(19) United States
(12) Patent Application Publication
(10) Pub. No.: US 2016/0200341 A1
(43) Pub. Date: Jul. 14, 2016

(54) Transportable and Washable Sanitary Cover for a Shopping Cart Handle

(71) Applicant: Dia Hall, (US)

(72) Inventor: Dia Hall, (US)

(21) Appl. No.: 14/594,081

(22) Filed: Jan. 10, 2015

(51) Int. Cl. B62B 5/06

(52) U.S. Cl. CPC B62B 5/069

(57) ABSTRACT

The present sanitary handle cover relates to a shopping cart, pushcart, or stroller handle cover that prevents the passage of germs bacteria, dirt, bodily fluids, infectious agents, disease organisms, contaminants, or particles of debris from previous users to new users; additionally, the cover is able to be detached from a handle, folded for size reduction and storage, easily transported, and does not cross-contaminate itself during storage or transport.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC

Not Applicable

### BACKGROUND OF INVENTION

1. Technical Field

The present invention relates to shopping cart, pushcart, or stroller handle covers. Particularly the invention is a sanitary handle cover to prevent the passage of germs bacteria, dirt, bodily fluids, infectious agents, disease organisms, contaminants, or particles of debris from previous users to new users. Additionally, the cover is easily removable from a shopping cart or stroller handle for washing and later re-use, reducible in size for self-storage, easily transportable, and does not cross-contaminate itself during storage or transport.

2. Description of Related Art

The use of shopping carts are widespread and have multifunctional purposes, with the most common currently being their use in grocery stores and retail stores, to enable users with the ability to carry and transport a large volume of items they otherwise would be incapable carrying, and to increase the ease at which these items can be carried and transported. Similarly, pushcarts and strollers enable the user to carry and transport a number of items above an otherwise prohibitive limit, and increase the ease of which these items are carried or transported. Conventional shopping carts and the like include a wheeled frame on which is provided a storage basket. A horizontal handle extends from one end of the basket to the other to enable users with a point of contact to apply force to the cart in an effort to push the cart in a longitudinal direction.

The multiple users of these push carts and the high frequency of their use by the multiple users creates various sanitation issues, namely the easy transmission of germs, bacteria, dirt, bodily fluids, infectious agents, disease organisms, contaminants, or particles of debris. Cart users contribute to the accumulation of these various sanitation issues by the unprotected touching of the cart handles, when their hands have been used for eating, touching their own bodily fluids, and touching various other unclean items such as money, doors, and other people. The frequent handling of these carts necessarily involves the accumulation of the aforementioned sanitation concerns, and successive users are faced with protecting themselves from these concerns, and are therefore susceptible to the harms associated with coming into contact with these sanitation concerns. Harms occurring from contact with germs, bacteria, dirt, bodily fluids, infectious agents, disease organisms, contaminants, or particles of debris include infection, uncleanliness, sickness, general malaise, disease, physical trauma, and bruising.

Handles of carts are breeding grounds for the festering and accumulation of the countless germs and particles responsible for harms such as infection, uncleanliness, sickness, general malaise, disease, physical trauma, and bruising, and the handles of these carts are necessarily touched for the proper use of these carts. Also, the handles of carts are rarely cleaned by the business entities offering these carts for use by consumers. Transmission by way of contaminated carts is also one of the most effective modes of disease transmission, since the efficiency of transmission is maximized when touching of these infectious agents occur, as opposed to being in common areas without touching and relying on infection by way of inhaling a satisfactory amount of infectious agent. In total, the necessary touching of rarely cleaned carts where transmission efficiency is at its most effective creates an unavoidable danger, requiring the institution of precautionary measures.

A pervasive germ-conscious culture also exacerbates the need for precautionary measures that combat the sanitation concerns created by frequent and unprotected handling of cart handles. The notable prevalence of personal hand sanitizers available for purchase at countless businesses and a similar prevalence of strategically placed sanitizing solutions at health care facilities highlights the increased cultural significance and relatedly high demand for sanitary protections from the countless germs our hands come in contact with throughout the day.

Past attempts at combatting this concern have been accompanied by various disadvantages, which are solved by this current invention.

As recently disclosed in U.S. Pat. No. 8,109,524 B1, a Shopping Cart Handle Cover discloses several shopping cart handle cover embodiments. For all embodiments, it is disclosed that a top cover panel will include a top panel longitudinal handle perforations, where a flexible cover panel handle flap maybe defined by and between the longitudinal perforations, to accommodate hands of a user, to enable protection under the users hands when grasped by the user. The flexible panel handle flap fails to provide a satisfactory coverage area of protection, and therefore fails in its core purpose. The flexible cover panel handle covers a maximum surface area the width of the flexible panel handle flap, and when grasped by user hands, segments of exposed cart handle protrude from each side of the grasped flexible panel handle flap. For a high majority of cart users, where user hands, or portions thereof, extend further than the width of the flexible panel handle flap, which I have found is a likely occurrence for larger hands or users that move their hands often when grasping a handle, then the primary function of germ protection is lost. Alternatively, the current invention extends considerably to the far ends of a standard shopping cart handle, completely and circumferentially encompassing the entire surface area of the contaminated shopping cart handle, which solves the shortcoming of surface area under-protection found in prior art such as '524 B1.

As recently disclosed in U.S. Pat. No. 6,543,794 B1, a Shopping Cart Sanitary Handle Cover claims and discloses a novelty and object of convenience of storage of a sanitary cart handle cover device, through the use of spring clip fasteners depending from opposed corresponding lateral edges of the invention, which enables the sanitary handle cover to be coupled to a bag or purse and serve an additional purpose of a shoulder strap to a bag or purse, which is a notably convenient location to store the invention. Where users of '794 B1 are non-users of purses or bags requiring shoulder straps, I have found that the novel feature of this device is severely undermined, and fails in performing a disclosed object of the invention. Where a majority of most men and a minority of women do not wear bags or purses requiring straps, during the completion of daily errands, and according to the most recent 2010 U.S. Census, 49.2% of the U.S. population (151.8 million people) is male—evidencing that a substantial demographic will be failed by this device and its novel element of transportability will be inaccessible. A necessary feature of transportability for a sanitary handle cover device is to ensure the feature is accessible to all users, and ensure that no gender bounds limit its access, especially when these bounds isolate nearly 152 million people. Furthermore, I have found that '794 B1 fails to satisfactorily offer the convenience intended from its storage pocket fixedly attached to its inner surface, which is configured to selectively receive a writing instrument. A necessary accompaniment to a writing instrument is a surface to receive and display content inscribed by the writing instrument. The writing instrument storage pocket of '794 B1, albeit sufficient in providing a convenient storage repository for a useful writing instrument, fails in providing an adequate repository for a writing instrument's necessary complement—a surface on which to inscribe—which severely mitigates the usefulness of the writing instrument repository feature. I have found that by providing a storage area within the shopping cart handle cover for a thin and bendable substantially rectangular material, such as a piece of paper on which to write a shopping list, then a truly useful repository for a shopping cart tool is created, undermining the usefulness of the '794 B1 writing instrument repository.

As recently disclosed in U.S. Pat. No. 5,722,672, a Reusable Protective Cover for Shopping Cart Handle/Rented Strollers claims and discloses, in addition to an ability provide a protective, washable, reusable, reducible in size, and transportable cover for push carts, I have found that it fails to provide reducible and transportable features that can coexist in harmony with its protective and sanitary purpose. After an initial use of '672 where contaminated surfaces are covered and protected against for a user, the subsequent folding for convenient storage during transport unavoidably cross-contaminates sanitary surfaces of '672 with contaminated surfaces. The contaminated surfaces of '672 that had come in contact with the surfaces of the cart handle where germs have accumulated are necessarily folded upon sanitary surfaces intended to be clean and free of contact with the germs. Therefore, when a user must visit more than one (1) location, necessitating the protection of a cart handle cover, before they are able to wash their cart handle cover for reuse, then the inevitable cross-contamination prevalent here severely undermines the core function of '672 and bolsters that of the current invention, which is to provide adequate protection in a convenient fashion, that can be transported without compromise of any other useful feature.

In light of the shortcomings of the above inventions, there is a need for a protective cart handle covering, that is washable, reusable, and transportable, that can serve useful to a substantial majority, and can be used on consecutive occasions without having its germ protection efficacy compromised when folded during periods of non-use where clean surfaces are contaminated by its own contaminated surfaces.

None of the above inventions, taken either singly or in combination, is seen to describe the instant invention as claimed.

### BRIEF SUMMARY OF THE INVENTION

The present invention includes a single substantially rectangular sheet, with first and second longitudinal edges extending between opposed first and second lateral edges, forming a rectangular shape, having inner and outer surfaces, with a tie attached to the outer surface, and with a connector attached to the outer surface. The sheet is constructed of a flexible and durable textile. The tie is arranged to wrap around and secure close the folded invention. The connector is arranged to form a fastener for attaching to a belt, loop, purse, keychain, or clothing of a user. The tie can also be used as a connector.

The opposed first and second lateral edges define a width dimension such that the cover may be wrapped circumferentially around a cart handle, and allow for portions of the cover to overlap one another at opposed longitudinal edges to enable fasteners on opposed longitudinal edges to mate, while the inner surface of the cover engages the surface of the cart handle. The opposed first and second lateral edges will be folded in a longitudinal direction upon themselves and secured to define an opening for an elastic band to be attached therein, which will serve to aid in increasing tension circumferentially about the cart handle, to secure the cover about the cart handle, minimizing horizontal displacement and rotational displacement of the cover on the cart handle. The said fasteners include, but are not limited to, hook and loop fasteners.

The opposed first and second longitudinal edges define a width dimension such that the cover may protectively cover at least the width of a standard grocery push cart, when the cover is wrapped about the cart handle cover.

The inner surface of the first longitudinal edge will have a plurality of fasteners mounted in spaced apart relation thereon. Similarly, on the outer surface of the second opposed longitudinal edge, a plurality of corresponding fasteners will be mounted in spaced apart relation thereon, such that they engage in complement to fasten to the first plurality of fasteners, to aid in securing the cover circumferentially about the cart handle, minimizing horizontal displacement and rotational displacement. The said plurality of fasteners include, but are not limited to, hook and loop fasteners.

The sheet will also have a plurality of fasteners mounted in spaced apart relation thereon, at two corresponding locations on the inner surface, which engage in complement to fasten the sheet securely closed when the sheet is folded upon its inner surface, prior to storage or transport, so that the opposed sides of the inner surface mate, and prevent the outer sheet surface from touching the inner sheet surface.

The handle cover also includes a pocket fixedly attached to the inner surface of the sheet and defining an opening for receiving a variety of thin, bendable, rectangular materials therein, such as coupons and shopping lists. The said pocket should be constructed of a flexible, durable fabric, where a preferred embodiment is mesh fabric that will enable the user to see the contents of the pocket, without removing the contents from the pocket.

A general object of this invention is to provide a cover for a handle for a shopping cart, push cart, or stroller, that is configured to wrap around the cart handle, and that is protective, reusable, durable, reducible in size, transportable, and that does not cross-contaminate the inner and outer cover surfaces upon its reduction in size for transport, and that releasably attaches to cart handles.

It is the objective of this current invention to provide a protective cover for a handle for a shopping cart, push cart, or stroller, that provides a barrier between the surface of the said handle and the skin surface of the cart user, which will serve to mitigate the transfer of germs, bacteria, dirt, bodily fluids, infectious agents, communicable disease organisms, contaminants, or particles of debris, that have been left behind on the cart handle by previous users, and are likely to come in contact with the current cart user when the said user engages the handle during normal cart use, without the aid of the protective cover.

It is also the objective of this current invention to provide a protective cover for a handle of a shopping cart, push cart, or stroller, that engages an area of the cart handle that extends the width of a standard grocery store push cart handle, and does not leave the surface area of the potentially contaminated cart handle exposed at portions of the handle likely to be engaged by a cart user during their use of the cart handle and while gripping the cart handle.

It is also the objective of this current invention to provide a protective cover for a handle of a shopping cart, push cart, or stroller, that is re-usable, which releasably attaches to a cart handle and can be removed for use on a different cart handle.

It also the objective of this current invention to provide a protective cover for a handle of a shopping cart, push cart, or stroller, that is made of a flexible and durable textile, so that it will be able to withstand the deteriorative physical stress found in the iterative using, removing, storing, transporting, and washing of the cover.

It is also the objective of this current invention to provide a protective cover for a handle of a shopping cart, push cart, or stroller, that is able to be reduced in size for fast and efficient storage and transportation by the user.

It is also the objective of this current invention to provide a cover for a handle of a shopping cart, push cart, or stroller, that when not in use provides the prevention of cross-contamination of the two (2) separate surfaces of the cover, which includes one (1) surface that is meant to remain free from contact with the anticipated germs, bacteria, dirt, bodily fluids, infectious agents, communicable disease organisms, contaminants, or particles of debris, that have been left behind on the cart handle by previous users, and one (1) surface that is meant to solely engage the surface of the cart handle and the anticipated germs, bacteria, dirt, bodily fluids, infectious agents, communicable disease organisms, contaminants, or particles of debris, that have been left behind on the cart handle by previous users.

It is also the objective of this current invention to provide a cover of a handle for a shopping cart, push cart, or stroller, that is releasably attached to the cart handle, which will enable the user to disengage the protective cover from the cart handle, to enable removal of the cover for later use on another cart handle, or to enable removal of the cover for later washing, or to enable removal of the cover for storage of the cover prior to a later reattachment to another cart handle, and also to enable removal of the cover and fastening of the reduced size cover to a belt, loop, purse, keychain, or clothing of a user.

It is also the objective of this current invention to provide a cover of a handle for a shopping cart, push cart, or stroller, that will include an outer surface that will be engaged by cart users' hands when the cover is releasably attached to a cart handle, and that can showcase decorative indicia.

It is also the objective of this current invention to provide a simplistic and affordable cover of a handle for a shopping cart, push cart, or stroller, for the repetitive use of cart users.

Still yet another objective of this current invention is to provide a new and improved handle cover for a shopping cart that can overcome the disadvantages of the prior art.

These and other features, aspects and advantages of the present invention will become better understood with reference to the following description and appended claims. The accompanying drawings, which are incorporated in and constitute part of this specification, illustrate embodiments of the invention and, together with the description, serve to explain principles of the invention.

### BRIEF DESCRIPTION OF THE SEVERAL VIEWS OF THE DRAWING

FIG. 1 is a perspective view of a shopping cart with the sanitary covering invention applied thereon.

FIG. 2 is a plan view of sanitary cart handle covering invention, as shown in FIG. 1 in an open position, with the inner surface meant to engage the surface of the cart handle shown in full, and also with the pocket meant to receive materials therein fixedly attached to the inner surface, and also with the plurality of fasteners on the inner surface used to mate with the plurality of fasteners on the outer surface to secure the cart handle cover circumferentially around a cart handle, and also with a plurality of fasteners along the longitudinal edge, used to hold secure a cart handle cover folded at the lateral midpoint.

FIG. 3 is another plan view embodiment of the sanitary covering invention in an open position, as illustrated in FIG. 2, with the plurality of fasteners along the lateral edge, used to hold secure a cart handle cover folded at the longitudinal midpoint.

FIG. 4 is a plan view of a sanitary covering invention shown in FIG. 1 in an open position, with the outer surface meant to be engaged by the hands of a cart user shown in full, and also with plurality of fasteners on the outer surface, and also with the tying means to secure close the rolled invention fixedly attached to the outer surface shown in full, and also with decorative indicia on the outside surface shown in full.

FIG. 5 is a perspective view of a sanitary covering invention shown in FIG. 1 in an open position showing the plurality of fasteners applied on opposite surfaces, with the fastening means on the outside surface shown in full, and the plurality of fasteners on the opposite inside surface shown in phantom, and also with the decorative indicia shown in full.

FIG. 6 is a perspective view of a sanitary covering invention shown in FIG. 2 in an open position, with the open end of the pocket meant to receive materials therein fixedly attached to the inner surface, with the plurality of fasteners on the inner surface shown in full, and the plurality of fasteners on the opposite surface shown in phantom.

FIG. 7 is a pictorial illustration of one (1) embodiment of how the sanitary covering invention can be securely folded for size reduction, storage, and transport, while avoiding the mating and cross-contamination of the separate and opposite surfaces.

FIG. 8 is a pictorial illustration of one (1) embodiment of how the sanitary covering invention can be securely folded for size reduction, storage, and transport, while avoiding the mating and cross-contamination of the separate and opposite surfaces.

FIG. 9 is a pictorial illustration of how the sanitary covering invention is rolled, prior to being tied for size reduction, storage, and transport, while avoiding the mating and cross-contamination of the separate and opposite surfaces.

FIG. 10 is a front view of a sanitary covering invention that has been rolled and tied for size reduction, storage, transport, and the subsequent connecting to another object.

FIG. 11 is a front view of a sanitary covering invention that has been rolled and tied for size reduction, storage, transport, and the subsequent connecting to another object, with a connector attached to the outside surface.

FIG. 12 is a front view of a purse that has a sanitary covering invention, that has been rolled and tied for size reduction, storage, and transport, connected to its handle

FIG. 13 is a side view of a purse that has a sanitary covering invention that has been rolled and tied for size reduction, storage, and transport, connected to its handle.

### DETAILED DESCRIPTION OF ILLUSTRATIVE EMBODIMENTS

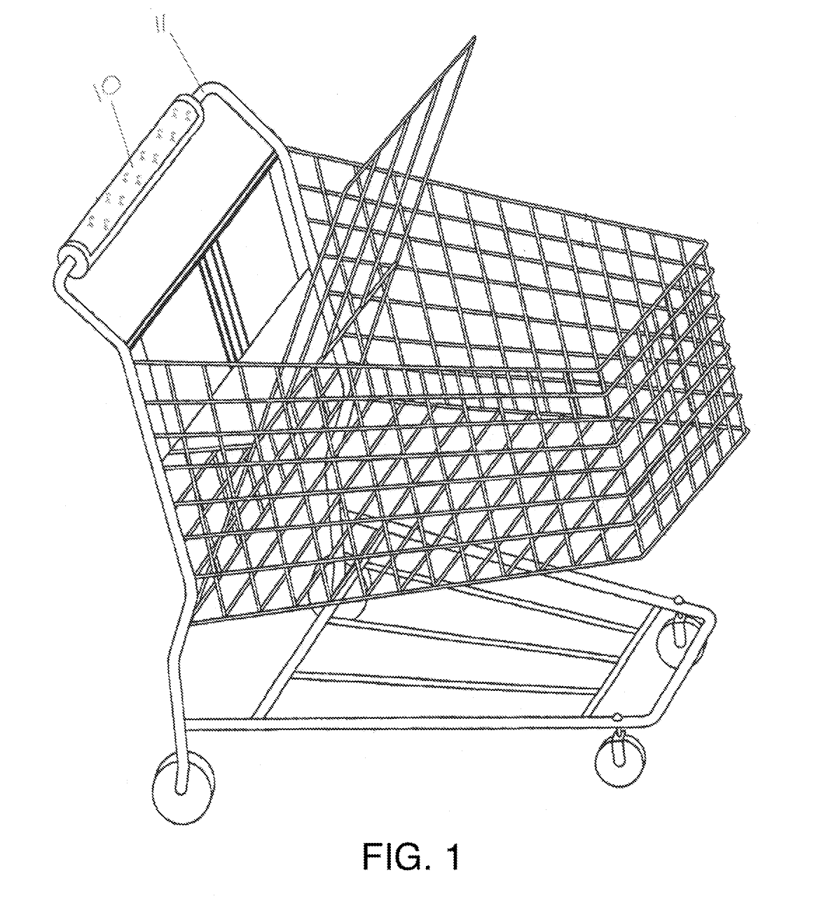

A protective, sanitary, washable, and transportable handle cover according to a preferred embodiment of the present invention will now be described with reference to FIGS. 1-13 of the accompanying drawings.

Referring now to FIG. 1 of the drawings, the handle cover 10 is circumferentially attached to the handle of the shopping cart 11, and extends a width across the cart handle so that the cover may protectively cover at least the width of a standard shopping cart handle.

Preferably, the handle cover 10 is made from a flexible, foldable, durable, semi-rigid material. The handle cover 10 may be made from any number of materials without departing from the spirit and scope of the present invention. What is desired is that the handle cover 10 be an economical, flexible, durable, washable, reusable device that can fit circumferentially over the handle of a standard shopping cart.

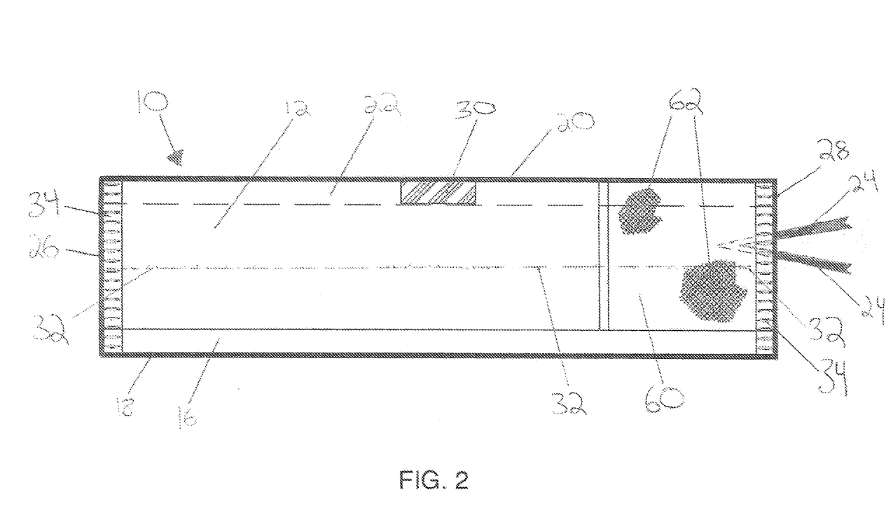

Referring now to FIG. 2 the inner surface 12 will engage the surface of the shopping cart handle. The inner surface 12 of the shopping cart handle cover is made to be substantially rectangular, defined by a first lateral edge 26 and second lateral edge 28, opposite one another, and further defined by a first longitudinal edge 18 and second longitudinal edge 20, opposite one another. Both first lateral edge 26 and second lateral edge 28 define a width so that the handle cover 10 can circumferentially and protectively cover a shopping cart handle. Both first longitudinal edge 18 and second longitudinal edge 20 define a width so that the handle cover 10 can extend longitudinally the width of a shopping cart handle. The inner surface 12 will engage the surface of the shopping cart handle in a circumferential manner.

A plurality of circular hook fasteners 16, such as VELCRO fasteners, are mounted in spaced apart relation on the inner surface 12 of the handle cover 10 along the first longitudinal edge 18. Similarly, a plurality of circular loop fasteners 22, such as VELCRO fasteners, shown in phantom, are mounted in spaced apart relation on the outer surface 14 of the handle cover 10 along the second longitudinal edge 20. Both fasteners 16 and 22 will engage and mate when the handle cover 10 is wrapped circumferentially around the cart handle to secure the handle cover 10 on the cart handle and to prevent rotational and horizontal displacement of the handle cover 10. When the handle cover 10 is to be removed from the cart handle for storage, transport, or for washing, the handle cover 10 may be disengaged from the cart handle by pulling apart the mated surfaces of the hook fasteners 16 and the loop fasteners 22.

A plurality of circular loop fasteners 30 mounted in spaced apart relation on the inner surface 12 of the handle cover are attached near the second longitudinal edge 20 and are used to engage the plurality of the circular hook fasteners 16 along the inner surface 12 of the first longitudinal edge 18, to hold secure a cart handle cover that is folded at the lateral midpoint 32, designated by the dotted line, extending across the inner surface from the first lateral edge 26 to the second lateral edge 28, which aids in ensuring the inner 12 and outer surface 14 never touch when the handle cover 10 is stored when not in use.

The handle cover 10 further includes a pocket 60 meant to receive materials therein fixedly attached to the inner surface 12. The fabric of the pocket 60 is made of a flexible and durable material 62, where a preferred embodiment of the fabric is mesh, which will allow for the user to see the contents of the pocket without needing to remove the pocket contents.

The handle cover 10 further includes, attached to the outer surface a means to secure the handle cover 10 in a rolled configuration, where securing means is preferred to be a tie 24, shown in full. The tie 24 assists in securing the rolled configuration 100 of the handle cover 10 and enhances its portability. The tie 24 will be a length to secure the rolled configuration of the handle cover 10 and also used as a connector to connect around rings or loops of a purse, bag, key chain, or pants, to aid in portability.

The handle cover 10 further includes elastic 34 integrated within the first lateral edge 26 and the second lateral edge 28 of the handle cover 10, which is used to increase the tension around the cart handle to minimize rotational and horizontal displacement of the handle cover 10.

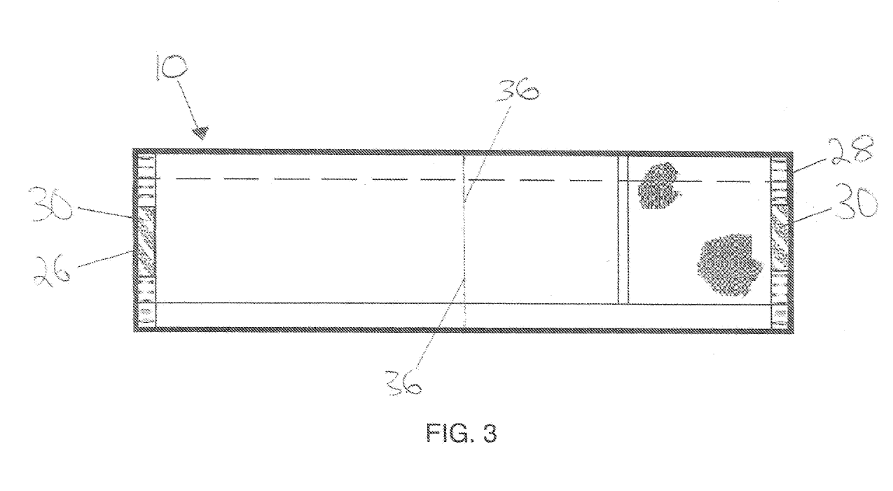

FIG. 3 is another plan view embodiment of the inner surface 12 of the handle cover, just as in FIG. 2, but where the plurality of fasteners 30 mounted in spaced apart relation on the inner surface 12, used to hold secure the folded handle cover, are substantially centered along both the first lateral edge 26 and the second lateral edge 28, to enable the cart handle cover 10 to be folded along the longitudinal midpoint 36.

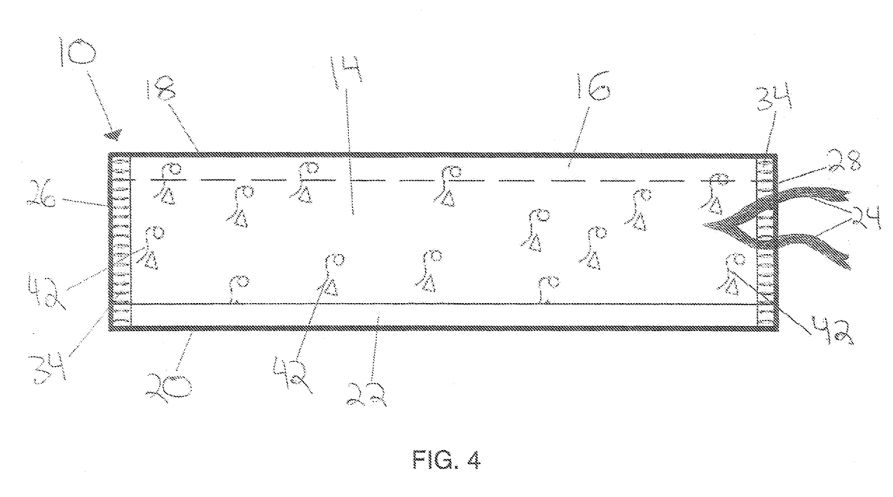

Referring now to FIG. 4 the outer surface 14 is made to be substantially rectangular, defined by a first lateral edge 26 and second lateral edge 28, opposite one another, and further defined by a first longitudinal edge 18 and second longitudinal edge 20, opposite one another. The substantially rectangular dimension of the outer surface 14 is equal to the dimensions of the inner surface 12. Similarly to the inner surface 12, both first lateral edge 26 and second lateral edge 28 define a width so that the handle cover 10 can circumferentially and protectively cover a shopping cart handle; and both first longitudinal edge 18 and second longitudinal edge 20 define a width so that the handle cover 10 can extend longitudinally the width of a shopping cart handle. The outer surface 14 will be engaged by a cart user when the cart user pushes the cart during use of the cart. The material of the outer surface also exhibits decorative indicia 42.

A plurality of circular loop fasteners 22, such as VELCRO fasteners, shown in full, are mounted in spaced apart relation on the outer surface 14 of the handle cover 10 of FIG. 4 along the second longitudinal edge 20. Similarly, a plurality of circular hook fasteners 16, are mounted in spaced apart relation on the inner surface 12 of the handle cover 10 along the first longitudinal edge 18.

The handle cover 10 of FIG. 4 further includes elastic integrated 34 within the first lateral edge 26 and the second lateral edge 28 of the handle cover 10, which is used to increase the tension around the cart handle to minimize rotational and horizontal displacement of the handle cover 10.

The handle cover 10 expressed in FIG. 4 further includes, attached to the outer surface 14 substantially near a lateral edge, a means to secure the handle cover 10 in a rolled configuration, where securing means is preferred to be a tie 24, shown in full. The tie 24 assists in greatly reducing the size of the handle cover 10 and enhances its portability, prior to securing the handle cover 10 to another object for transporting or storage. In use, the handle cover 10 may be attached to the rings or loops of a purse, bag, key chain, or pants, with the tie 24 or another connector.

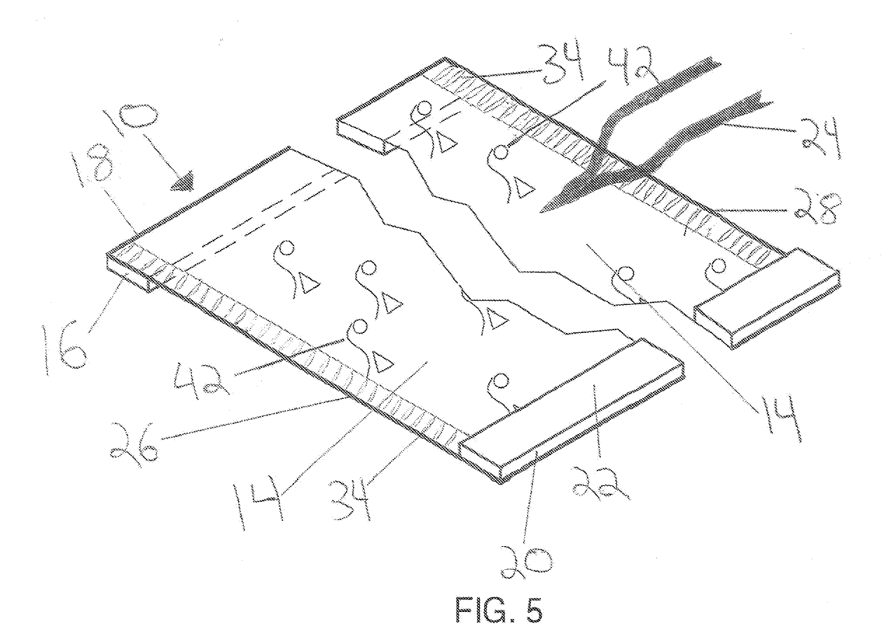

Referring now to FIG. 5 the isometric view of the handle cover 10 shows the hook fasteners 16 on the inner surface 12 and adjacent to the first longitudinal edge 18, and the loop fasteners 22 on the outer surface 14 and adjacent to the second longitudinal edge 20, which upon circumferential wrapping of the handle cover 10 around the cart handle, where the fasteners overlap, will engage one another in a mating fashion and create a considerably strong bond to ensure that the releasably attached handle cover 10 will remain securely attached to the cart handle without the application of a substantial force to disengage the handle cover by pulling apart the overlapping fasteners adjacent to the first longitudinal edge 18 and second longitudinal edge 20, respectively.

FIG. 5 further expresses, attached to the outer surface 14 substantially near a lateral edge, a means to secure the handle cover 10 in a rolled configuration, where securing means is preferred to be a tie 24, shown in full. Also, the decorative indicia 42 of the outer surface 14 is expressed in FIG. 5.

The handle cover 10 further includes elastic 34 integrated within the first lateral edge 26 and the second lateral edge 28 of the handle cover 10, which is used to increase the tension around the cart handle to minimize rotational and horizontal displacement of the handle cover 10.

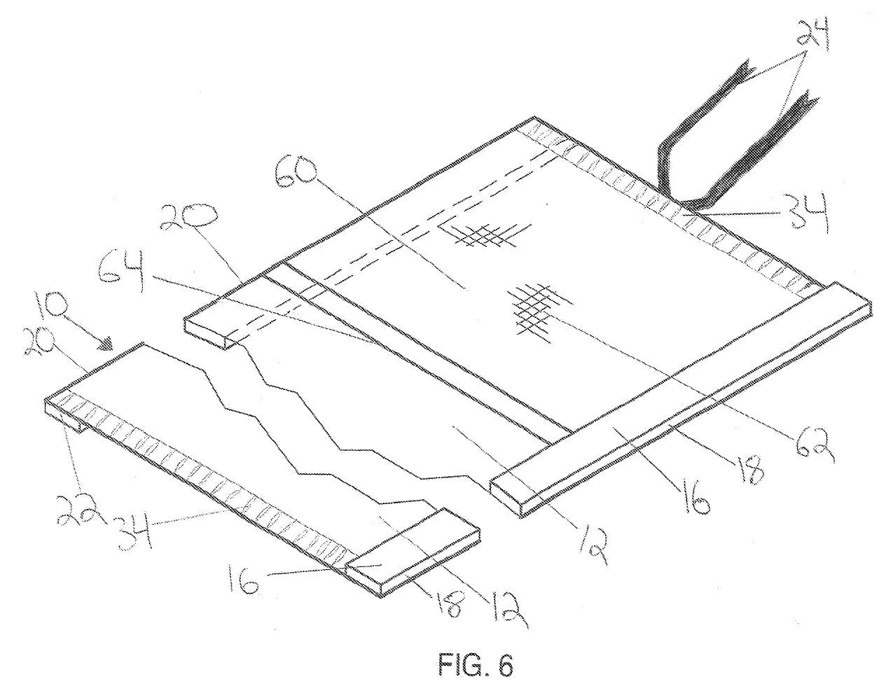

Referring now to FIG. 6 the isometric view of the handle cover shows the pocket 60 fixedly attached to the inner surface 12 of the handle cover 10. The pocket 60 has one open-end 64 meant to receive materials therein. The pocket 60 extends longitudinally therealong the inner surface 12 and therealong the plurality of fasteners 16 adjacent to the first longitudinal edge 18. Preferably, the pocket 60 is made from a durable, flexible, foldable material 62. The pocket 60 may be made from any number of fabrics without departing from the spirit and scope of the present invention, although a preferred embodiment of the fabric is mesh, which will allow for the user to see the contents of the pocket without needing to remove the pocket contents. A substantially flat and foldable material may be inserted in the pocket 60 through the open end 64, for storage in the handle cover 10 when either attached circumferentially to the shopping cart handle or when in a rolled configuration 90.

FIG. 6 also shows the hook fasteners 16 on the inner surface 12 and adjacent to the first longitudinal edge 18, and the loop fasteners 22 on the outer surface 14 and adjacent to the second longitudinal edge 20

In actual use, when the handle cover 10 is disengaged from the cart handle and is intended to be folded and rolled for storage and later use, the user can perform this function without contaminating the sanitary outer surface 14 with the germ and contaminant-ridden inside surface 12. The outer surface 14 is meant to remain free from the countless germs, bacteria, dirt, and other contaminants protected against by the handle cover 10. The inner surface 12 is meant to engage the countless germs, bacteria, dirt, and other contaminants likely hosted by the cart handle when the inner surface engages the cart handle. Both the inner surface 12 and outer surface 14 are meant to remain exclusively apart and meant to never to come in contact with one another, so as to ensure that contamination of the sanitary outer surface 14 is not compromised by the contaminants prevalent on the inner surface 12.

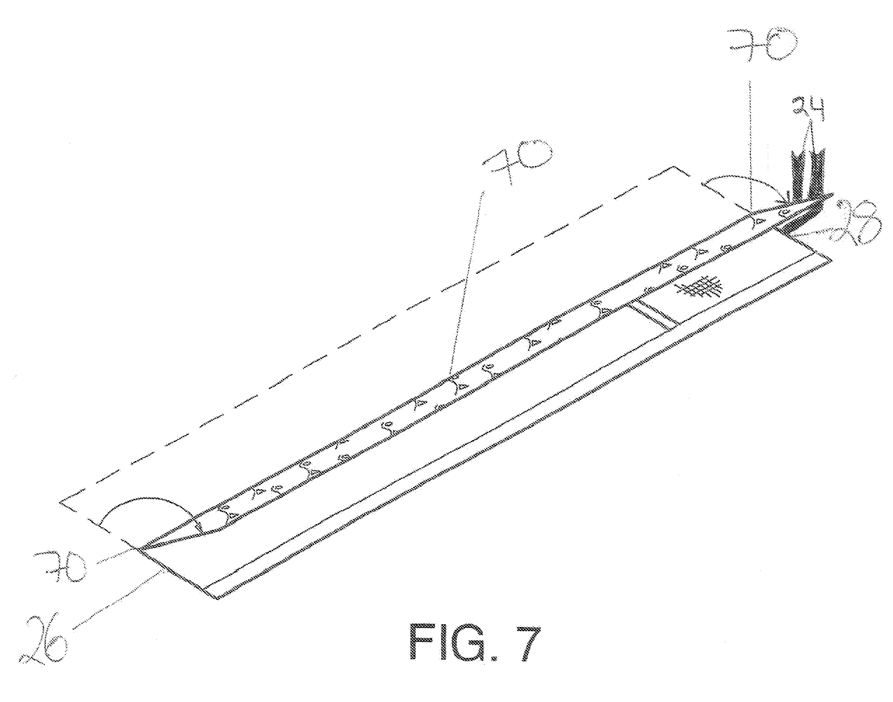

The handle cover 10 can be folded so that the inner surface 12 and the outer surface 14 remain exclusively apart and never mate. As illustrated in FIG. 7, in one (1) embodiment of the way the handle cover may fold, the inner surface of the handle cover 10 is folded upon itself at the lateral midpoint 70 of the handle cover 10, which traverses longitudinally from the midpoint of the first lateral edge 26 to the midpoint of the second lateral edge 28, in a line substantially perpendicular to both the first lateral edge 26 and second lateral edge 28. After folding the handle cover 10, as illustrated in FIG. 7, the cover can be rolled up for storage or transport.

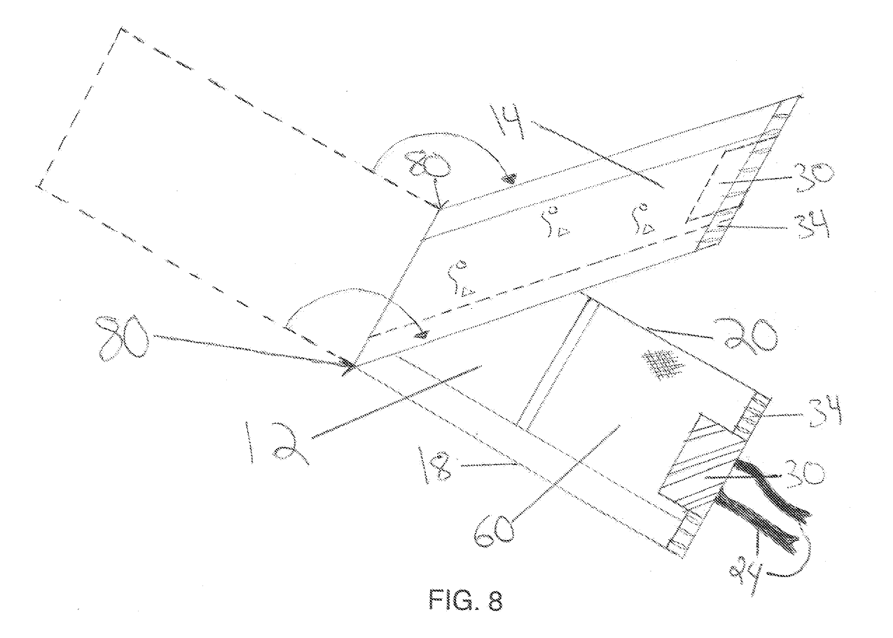

FIG. 8 illustrates another embodiment of how the handle cover can be folded with the inner surface 12 and the outer surface 14 remaining exclusively apart and never mating. The inner surface is folded upon itself at the longitudinal midpoint 80 of the handle cover 10, which traverses laterally from the midpoint of the first longitudinal edge 18 to the midpoint of the second longitudinal edge 20 in a line substantially perpendicular to both the first longitudinal edge 18 and the second longitudinal edge 20.

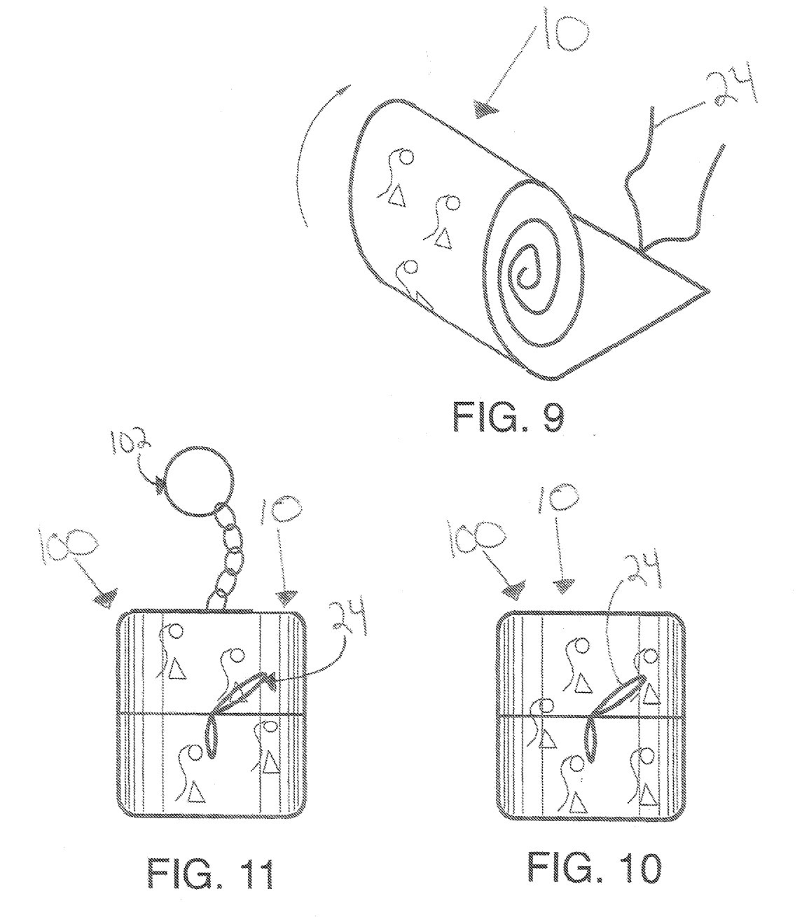

As illustrated in FIG. 9, the handle cover 10, after folding pursuant to FIG. 7 or FIG. 8, is then rolled from one lateral edge to the other opposite lateral edge, where only the outer surface 14 is visible, in a manner to allow for the securing tie 24 to remain accessible for securing the rolled configuration 100 of the handle cover 10, since the tying means to secure will be substantially near a lateral edge of the handle cover 10.

Referring now to FIG. 10, the handle cover 10 is secured in a rolled configuration 100 by a tie 24, comprised of ribbon-like fabric connected to the outer surface 14 of the handle cover 10, at a location along the width dimension of a lateral edge so that the securing tie will be substantially centered on the outer surface 14 of the rolled configuration 100, that ensures substantially balanced halves of the length of the handle cover 10 in the rolled configuration 100 are on opposite sides of the tie 24. The tie 24 will also be a length to also be used as a connector, to allow for the handle cover to be connected to another object when the handle cover 10 is stored and not in use.

Referring now to FIG. 11, an alternative embodiment of the means to connect the handle cover to another object when the handle cover 10 is stored and not in use is shown. The alternative embodiment shows the handle cover 10 is secured in a rolled configuration 100 as in FIG. 10, but the means to connect the handle cover 10 to another object when the handle cover 10 is stored and not in use, here is a keychain 102, which is attached to the outer surface 14 of the handle cover 10.

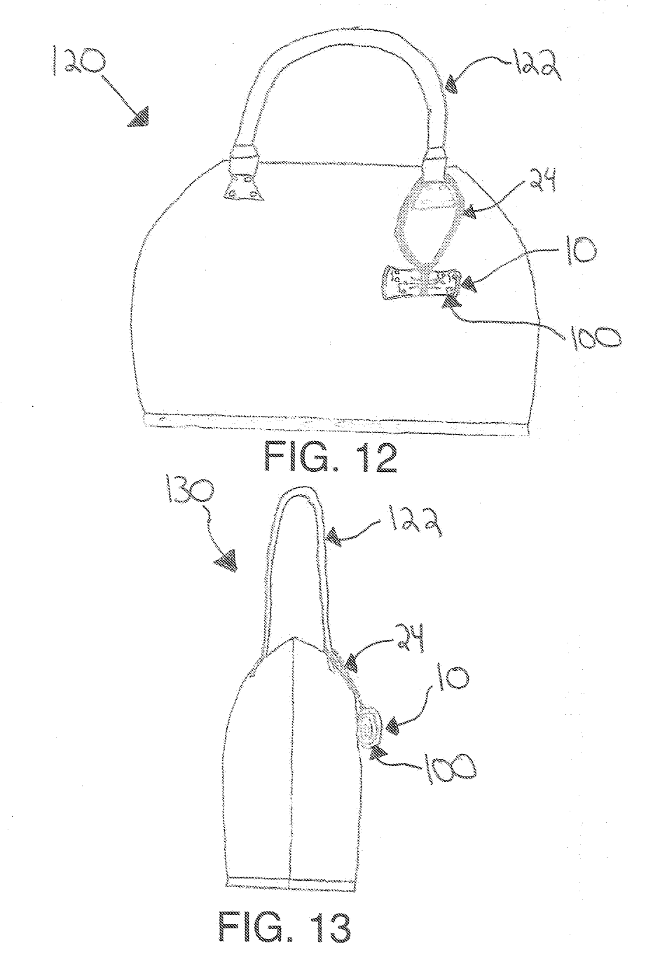

Referring now to FIG. 12, a purse 120 is shown with the handle cover 10 in a rolled configuration 100 connected by its tie 24 to a purse handle 120. This connection allows the user to store the handle cover 10 when not in use, and to transport the handle cover 10 with them between uses.

Referring now to FIG. 13, a side view of a purse 130 is shown, where the handle cover 10 is shown in a rolled configuration 100 and utilizing its tie 24 as a connector to attach itself to a purse handle 120. This connection allows the user to store the handle cover 10 when not in use, and to transport the handle cover 10 with them between uses.

It should be appreciated that modifications and alterations obvious to those skilled in the art are not to be considered as beyond the scope of the present invention. For example, in the preferred embodiment, elastic is integrated within a lateral edge of the cover to securing the cover about the cart handle, preventing horizontal displacement and rotational displacement of the cover. In an alternative embodiment, any other effective material may be integrated within the lateral edge of the cover to secure the cover about the cart handle, preventing horizontal displacement and rotational displacement of the cover. Also, for example, the tie for securing the invention closed in a rolled configuration is on the lateral edge. In an alternative embodiment, the tie for securing the invention closed in a rolled configuration is on the longitudinal edge.

In the preferred embodiment, the material of the cover is a flexible vinyl material. In an alternative embodiment, the material of the cover is plastic, or cotton, or leather, or biodegradable.

What is claimed is:

1. A removable, foldable, washable, reusable, protective cover for a shopping cart handle used to protect a cart user from contact with the unsanitary conditions of cart handles, that does not self-contaminate its sanitary surface upon folding, comprising:
a. A substantially rectangular semi-flexible sheet having an inner surface and an outer surface; with said sheet having corresponding first and second longitudinal edges extending between corresponding first and second lateral edges;
b. Said corresponding longitudinal edges of said sheet defining a width so that said sheet may sufficiently cover the longitudinal width of a standard shopping cart handle;
c. Said corresponding lateral edges of said sheet defining a width so that said sheet may sufficiently circumferentially encase said cart handle and overlap at corresponding longitudinal edges;
d. Said corresponding lateral edges of said sheet folded longitudinally to encase an elastic band used to increase tension circumferentially at said lateral edges to mitigate longitudinal and rotational displacement;
e. A plurality of circular hook fasteners longitudinally spaced apart on the inner surface adjacent to the first longitudinal edge;
f. A plurality of circular loop fasteners longitudinally spaced apart on the outer surface adjacent to second longitudinal edge, so that said hook and loop fasteners may engage one another when said sheet is circumferentially encased about said cart handle, to ensure a secure circumferential fit of said sheet around said cart handle to mitigate rotational and horizontal displacement of said sheet;
g. A plurality of circular loop fasteners longitudinally spaced apart on the inner surface adjacent to the second longitudinal edge, to engage said plurality of circular hook fasteners longitudinally spaced apart on the inner surface adjacent to the first longitudinal edge, after folding said sheet, to secure close inner surface and to prevent both the inner and outer surfaces of said sheet from touching one another;
h. A storage pocket fixedly attached to the inner surface of said sheet, said pocket with one open end to receive material therein;
i. Said sheet having a tie fixedly attached to the outer surface of said sheet used to secure said sheet that has been rolled after folding, by wrapping around and tying close rolled sheet; and
j. A connector fixedly attached to the outer surface of said sheet, to enable the attachment of a securely rolled sheet to a belt, loop, purse, keychain, or clothing of a user, wherein said tie is a length dimension so that tie can be used to secure close rolled sheet and be arranged to form said connector.

2. The protective cover of claim 1, wherein said open end of said storage pocket defines a width wider than that of a standard pen or pencil.

3. A removable, foldable, washable, reusable, protective cover for a shopping cart handle used to protect a cart user from contact with the unsanitary conditions of cart handles, that does not self-contaminate its sanitary surface upon folding, comprising:
a. A substantially rectangular semi-flexible sheet having an inner surface and an outer surface; said sheet having corresponding first and second longitudinal edges extending between corresponding lateral edges;
b. Said corresponding longitudinal edges of said sheet defining a width so that said sheet may sufficiently cover the longitudinal width of a standard shopping cart handle;
c. Said corresponding lateral edges of said sheet defining a width so that said sheet may sufficiently circumferentially encase said cart handle and sufficiently overlap at corresponding longitudinal edges;
d. Said corresponding lateral edges of said sheet folded longitudinally to encase an elastic band used to increase tension circumferentially at said lateral edges to mitigate longitudinal and rotational displacement;
e. A plurality of circular hook fasteners longitudinally spaced apart on the inner surface adjacent to the first longitudinal edge;
f. A plurality of circular loop fasteners longitudinally spaced apart on the outer surface adjacent to second longitudinal edge, so that said hook and loop fasteners may engage one another when said sheet is circumferentially encased about said cart handle to ensure a secure circumferential fit of said sheet around said cart handle to mitigate rotational and horizontal displacement of said sheet;
g. A plurality of circular hook fasteners laterally spaced apart on the inner surface adjacent to the first lateral edge;
h. A plurality of circular loop fasteners laterally spaced apart on the inner surface adjacent to second lateral edge, so that said hook and loop fasteners laterally spaced apart on the inner surface adjacent to the first and second lateral edge may engage one another when said sheet is folded close to secure close inner surface and to prevent both the inner and outer surfaces of said sheet from touching one another;
i. A storage pocket fixedly attached to the inner surface of said sheet, said pocket with one open end to receive material therein;
j. Said sheet having a tie fixedly attached to the outer surface of said sheet used to secure said sheet that has been rolled after folding, by wrapping around and tying close rolled sheet; and
k. A connector fixedly attached to the outer surface of said sheet, to enable the attachment of a securely rolled sheet to a belt, loop, purse, keychain, or clothing of a user, wherein said tie is a length dimension so that tie can be used to secure close rolled sheet and be arranged to form said connector.

4. The protective cover of claim 3, wherein said open end of said storage pocket defines a width wider than that of a standard pen or pencil.

5. A removable, foldable, washable, reusable, protective cover for a shopping cart handle used to protect a cart user from contact with the unsanitary conditions of cart handles, that does not self-contaminate its sanitary surface upon folding, comprising:
a. A substantially rectangular semi-flexible sheet having an inner surface and an outer surface; said sheet having corresponding first and second longitudinal edges extending between corresponding lateral edges;
b. Said corresponding longitudinal edges of said sheet defining a width so that said sheet may sufficiently cover the longitudinal width of a standard shopping cart handle;
c. Said corresponding lateral edges of said sheet defining a width so that said sheet may sufficiently circumferentially encase said cart handle and sufficiently overlap at corresponding longitudinal edges;
d. Said corresponding lateral edges of said sheet folded longitudinally to encase an elastic band used to increase tension circumferentially at said lateral edges to prevent horizontal and rotational displacement;
e. A plurality of circular hook fasteners longitudinally spaced apart on the inner surface adjacent to the first longitudinal edge;
f. A plurality of circular loop fasteners longitudinally spaced apart on the outer surface adjacent to second longitudinal edge, so that said hook and loop fasteners may engage one another when said sheet is circumferentially encased about said cart handle to ensure a secure circumferential fit of said sheet around said cart handle to mitigate rotational and horizontal displacement of said sheet;
g. A fastener fixedly attached to inner surface of said sheet to secure close inner surface of said sheet upon folding of inner surface upon itself to prevent both the inner and outer surfaces of said sheet from touching one another;
h. A storage pocket fixedly attached to the inner surface of said sheet, said pocket with one open end to receive material therein;
i. Said sheet having a tie fixedly attached to the outer surface of said sheet used to secure said sheet that has been rolled after folding, by wrapping around and tying close rolled sheet; and
j. A connector fixedly attached to the outer surface of said sheet, to enable the attachment of a securely rolled sheet to a belt, loop, purse, keychain, or clothing of a user, wherein said tie is a length dimension so that tie can be used to secure close rolled sheet and be arranged to form said connector.

6. The protective cover of claim 5, wherein said open end of said storage pocket defines a width wider than that of a standard pen or pencil.
